(19) United States
(12) Patent Application Publication
(10) Pub. No.: US 2025/0197014 A1
(43) Pub. Date: Jun. 19, 2025

(54) AERONAUTICAL THRUSTER

(71) Applicant: SAFRAN AIRCRAFT ENGINES, PARIS (FR)

(72) Inventors: Fernando GEA AGUILERA, MOISSY-CRAMAYEL (FR); Eva Julie LEBEAULT, MOISSY-CRAMAYEL (FR); Anthony BINDER, MOISSY-CRAMAYEL (FR); Mathieu Patrick Jean-Louis LALLIA, MOISSY-CRAMAYEL (FR)

(21) Appl. No.: 18/845,543

(22) PCT Filed: Mar. 3, 2023
(86) PCT No.: PCT/FR2023/050294

§ 371 Date: Sep. 10, 2024

(30) Foreign Application Priority Data
Mar. 11, 2022 (FR) 2202172

(51) Int. Cl. B64D 27/10; F04D 29/54; F04D 29/56

(52) U.S. Cl. CPC B64D 27/10; F04D 29/544; F04D 29/563

(57) ABSTRACT

An aeronautical thruster of longitudinal axis has a hub, an annular row of unducted upstream rotor blades and an annular row of unducted downstream stator blades. Each downstream stator blade is of variable pitch, and at least one of the downstream stator blades is in a closed-pitch configuration relative to another of the downstream stator blades in that it has a pitch angle smaller than the pitch angle of the other downstream stator blade.

### TECHNICAL FIELD

The present disclosure relates to aeronautical thrusters with a longitudinal axis comprising (at least) two annular rows of unducted blades, one upstream and one downstream, along the longitudinal axis.

The aeronautical thruster can comprise (at least) one thermal engine, in particular turbomachine, turboshaft, turbojet, turbofan, and/or (at least) one electric motor, and/or (at least) one hydrogen engine, and/or (at least) one hybrid engine: thermal and/or electric and/or hydrogen.

### PRIOR ART

In the following, we will only refer to the case of turbomachines, since the type(s) of engine(s) included in the aeronautical thruster is not decisive here.

An “unducted” turbomachine (or “Propfan” or “Open rotor” or “Counter-Rotating Open Rotor” turboprop) is a type of turbomachine in which the fan (or propeller) extends outside the engine casing (or basket), in contrast to conventional turbomachines (of the “Turbofan” type) in which the fan is ducted. An example of such a turbomachine is shown in FIG. 1. The turbomachine 10 comprises a hub 12, defining the engine housing, and having mounted thereon an annular row of unducted upstream blades 14 and an annular row of unducted downstream blades 16 which are spaced apart from each other along a longitudinal axis X of the turbomachine 10. The annular row of upstream blades 14 and the annular row of downstream blades 16 define an upstream and downstream propeller respectively. Orientation qualifiers, such as “longitudinal”, “radial” or “circumferential”, are defined with reference to the longitudinal axis X of the turbomachine 10. The relative terms “upstream” and “downstream” are defined with respect to each other with reference to the flow of gases in the turbomachine 10 along the longitudinal axis X. Furthermore, the turbomachine 10 comprises, from upstream to downstream inside the engine casing, one or more compressors 2, at least one combustion chamber 4, one or more turbines 6 and at least one exhaust nozzle 8.

Amongst these unducted fan turbomachines, we know the “Unducted Single (or Stator) Fan” (USF) turbomachines in each of which, as illustrated in FIG. 1, the annular row of unducted upstream blades 14 is mounted so as to be able to rotate around the longitudinal axis X and the annular row of unducted downstream blades 16 is fixed. In other words, the annular row of upstream blades 14 is of the rotor type and the annular row of downstream blades 16 is of the stator type. The direction of rotation of the upstream rotor blades 14 is not decisive. The annular row of downstream stator blades 16 can be centred on an axis coincident or not with the longitudinal axis X. As shown in FIG. 1, the annular row of downstream stator blades 16 is centred on the longitudinal axis X. Such a USF configuration allows the gyration energy of the airflow from the upstream propeller to be utilised through the downstream propeller 16. The efficiency of the turbomachine 10 is thus improved, especially compared to a conventional turbomachine with a single rotating propeller. The upstream unducted rotor blades 16 are driven in rotation about the longitudinal axis X by the turbine(s) 6 which itself drives the compressor(s) 2. The turbomachine 10 usually includes a gearbox to decouple the speed of rotation of the turbines 6 from the speed of rotation of the upstream propeller. Furthermore, one of the advantages of a USF type turbomachine compared to a “Counter-Rotating Open Rotor” type turbomachine is to reduce the tonal noise emitted by the turbomachine due to the fact that the unducted downstream stator blades 16 are not driven in rotation around the longitudinal axis X.

The turbomachine 10 can have a “Pusher” configuration in which the upstream rotor blade annular row 14 and the downstream stator blade annular row 16 are located at a downstream end portion of the turbomachine 10 (the configuration shown in FIG. 1), or the turbomachine 10 can have a “Puller” configuration in which the annular row of upstream rotor blades 14 and the annular row of downstream stator blades 16 are located at an upstream end portion of the turbomachine 10.

In the Puller configuration, the annular row of upstream rotor blades 14 and the annular row of downstream stator blades 16 can surround a section of the compressor(s) 2 of the turbomachine or the gearbox. In the Pusher configuration, the annular row of upstream blades 14 and the annular row of downstream stator blades 14 can surround a section of the turbine(s) 6 of the turbomachine 10.

The absence of a fairing leads to an increase in the noise level emitted by the turbomachine 10. This is because the noise generated by the annular rows of unducted upstream rotor blades 14 and downstream stator blades 16 is propagated in the free field. A main cause of the noise emitted is related, firstly, to the interaction of the wake of the upstream rotor blades 14 on the downstream stator blades 16, and, secondly, to vortex structures generated in the airflow at the free radially outer ends of the upstream rotor blades 14 which impact on the downstream stator blades 16.

However, too much noise is detrimental to the comfort of the passengers of the aircraft on which the turbomachine is installed. In addition, the current standards impose a maximum noise threshold, particularly in the area close to the ground, i.e. during the take-off and landing phases.

Furthermore, when the upstream airflow perceived by the turbomachine 10 is not parallel to the longitudinal axis X (in particular during the landing and take-off phases), the forces generated on each upstream rotor blade 14 vary according to the position around the longitudinal axis X of the upstream rotor blade 14 during its rotation around the longitudinal axis X. Thus the directivity of the far field acoustic radiation is not axisymmetric. Also, the incidence of the airflow perceived by the turbomachine 10 is modified by the upstream propeller heterogeneously around the longitudinal axis X. As a result, the aerodynamic load applied to each of the downstream stator blades 16 differs depending on the position around the longitudinal axis X of the downstream stator blade 16, which can lead to unsatisfactory thrust provided by the downstream propeller during phases of operation at incidence of the turbomachine 10, in particular during the landing and take-off phases.

Furthermore, in operation, the presence of aircraft structural elements (mast, fuselage, wing, slat, flaps, etc.) located in the vicinity of the downstream propeller can modify the airflow conditions (pressure, longitudinal component of the flow velocity, etc.), locally around the longitudinal axis X, at the level of the downstream stator blade ring row 16. However, a heterogeneous airflow around the longitudinal axis X at the downstream propeller also has the disadvantage of causing an aerodynamic load applied to each of the downstream stator blades 16 which differs depending on the position around the longitudinal axis X of the downstream stator blade 16.

### SUMMARY OF THE INVENTION

An aeronautical thruster of longitudinal axis is proposed comprising a hub, an annular row of unducted upstream rotor blades and an annular row of unducted downstream stator blades, the annular row of upstream rotor blades and the annular row of downstream stator blades being spaced apart along the longitudinal axis, each downstream stator blade being variably staggered, and wherein at least one of the downstream stator blades is in a closed staggered configuration relative to another of the downstream stator blades in that it has a smaller pitch angle than the pitch angle of the other downstream stator blade.

Each downstream stator blade can thus be rotated about its pitch axis to change the angle of incidence of the airflow on the downstream stator blade. The rotational adjustment of each downstream stator blade around the respective pitch axis can be carried out as a function of an incidence phase of the aeronautical thruster (e.g. landing phase and/or take-off phase), and/or as a function of airflow conditions taken locally at the level of the downstream stator blade, these can depend, depending on the position of the downstream stator blade around the longitudinal axis, on the wake of the upstream rotor blades and/or on the presence of structural elements of an aircraft on which the aeronautical thruster is mounted (mast, fuselage, wing, slat, flaps, etc.). This reduces the noise level of the aeronautical thruster and improves the aerodynamic performance of the downstream stator blade ring.

The annular row of upstream rotor blades is rotatable about the longitudinal axis. The annular row of unducted downstream stator blades is locked in rotation about the longitudinal axis. The annular row of downstream stator blades is therefore fixed around the longitudinal axis. In other words, the downstream stator blades are not rotated around the longitudinal axis.

The term “unducted” used in reference to the upstream rotor blades and downstream stator blades indicates that the upstream rotor blades and downstream stator blades are not surrounded by a basket, unlike conventional aeronautical thrusters where the fan is ducted within a basket.

The annular row of upstream rotor blades and the annular row of downstream stator blades can define an upstream propeller and a downstream propeller respectively. The downstream annular row of stator blades can be a rectifier.

Each blade (upstream and/or downstream) can extend radially. Each blade can extend between a radially inner end, which is located at (i.e. closest to) the hub of the aeronautical thruster, and a radially outer end. The radially inner end can be longitudinally at a leading edge of the blade or at the pitch axis of the blade. The radially inner end is also called the “root” of the blade. A position of each blade about the longitudinal axis can be identified by the position about the longitudinal axis of the radially inner end of the respective blade. The radially outer end of each blade is the opposite end of the radially inner end of the blade. The radially outer end can be the free end of the blade. The radially inner end and the radially outer end of each blade can be radially aligned and/or at the same longitudinal position. It is not excluded that the radially inner end and the radially outer end of each of the blades can be longitudinally and/or circumferentially offset from each other.

The position of each of the blades (upstream and/or downstream) about the longitudinal axis can be expressed as an angular position about the longitudinal axis. The angular position of each of the blades (upstream and/or downstream) can be marked in relation to a time dial (here seen from upstream for example) whose angular positions at 12H, 3H, 6H and 9H are positioned in a conventional manner. The angular position at 12H is therefore positioned vertically upwards with respect to the longitudinal axis. The angular position at 6H is therefore positioned vertically downwards with respect to the longitudinal axis. The angular position at 3H is positioned horizontally towards the right with respect to the longitudinal axis. The angular position at 6H is positioned horizontally towards the left with respect to the longitudinal axis. An axis extending radially through the angular positions at 12H and 6H is thus perpendicular to an axis extending radially through the angular positions at 3H and 9H. Absolute position qualifiers, such as “up”, “down”, “left”, “right”, etc., or relative position qualifiers, such as “above”, “below”, “upper”, “lower”, etc., and orientation qualifiers, such as “vertical” and “horizontal”, can be considered in an operational state of the aeronautical thruster, typically when installed on a grounded aircraft. In this state of the aeronautical thruster, the axis through the angular positions at 12H and 6H extends in the direction of the gravity field, i.e. vertically.

The angular position of each blade (upstream and/or downstream) can be defined by an angle measured around the longitudinal axis positively clockwise from the angular position at 12H. The angle can be measured between an axis perpendicular to the longitudinal axis of the aeronautical thruster passing through the radially inner end (or the radially outer end) of the downstream stator blade and the axis passing through the angular positions at 12H and 6H. Thus, the angular position of a blade located at the angular position at 12H can be defined by an angle θ qual to 0°, the angular position of a blade located at the angular position at 3H can be defined by an angle θ qual to 90°, the angular position of a blade located at 6H angular position can be defined by an angle θ qual to 180° (or equivalently to −180° and the angular position of a blade located at the angular position at 9H can be defined by an angle θ qual to 270° (or equivalently to −90°.

Each blade has a radially outer radius. The radially outer radius of a blade can be taken as the radial distance to the longitudinal axis of the radially outer end of the blade. In other words, it is the maximum radius of the blade. The maximum radially outer radius among the annular row of upstream rotor blades is the radially outer radius of the upstream propeller. Each upstream rotor blade can have an identical radially outer radius. In this case, the radially outer radius of each upstream rotor blade corresponds to the radially outer radius of the upstream propeller. The maximum radially outer radius of the annular row of downstream stator blades is the radially outer radius of the downstream propeller. Each downstream stator blade can have an identical radially outer radius. In this case, the radially outer radius of each downstream stator blade corresponds to the radially outer radius of the downstream propeller. The annular row of stator blades can comprise two stator blades (possibly circumferentially consecutive) which have a different radially outer radius from each other. The annular row of stator blades can comprise two stator blades (possibly circumferentially consecutive) which have a different radially outer radius from each other.

Each blade (upstream and/or downstream) can have an aerodynamic profile. For this purpose, each blade can comprise a stack of sections in the radial direction. For each blade, a stacking line can be defined that passes through the centre of gravity of each blade section. It is not impossible that the stacking line of one or more blades forms a non-linear curve. In one particular case, the stacking line of one or more blades can extend radially in a straight line. Each section extends in a respective section plane which is perpendicular to the radial direction of extension of the corresponding blade. Each section can comprise an upstream leading edge and a downstream trailing edge, between which extend a lower surface line (“intrados” line) and upper surface line (“extrados” line). Each section can define an aerodynamic profile. Each section can comprise a chord defined by a straight line portion connecting the leading edge to the trailing edge. When reference is made to the aerodynamic profile of a section or blade, this means the two-dimensional shape of the section, or respectively the three-dimensional shape of the blade, irrespective of the blade pitch angle or the angular position of the blade around the longitudinal axis.

The leading edge and trailing edge of all the sections in the stack of sections can form a leading edge and trailing edge of the blade respectively. Similarly, the lower and upper surface lines of all the sections in the section stack can form a lower surface face (“intrados” face) and upper surface face (“extrados” face) of the downstream stator blade, respectively, for each blade.

Each stator blade has a respective pitch axis. The pitch axis of each downstream stator blade can lie in a plane perpendicular to the longitudinal axis. In other words, the pitch axis of each downstream stator blade can extend in a direction with a zero longitudinal component. The pitch axis of each downstream stator blade can extend radially. It is not excluded that the pitch axis comprises a radial component and/or a longitudinal component and/or a circumferential component.

The pitch angle of each downstream stator blade can correspond to the angle formed between, firstly, a first axis which is defined by the intersection between the cross-sectional plane of a reference section among the stack of sections of the blade and a plane perpendicular to the longitudinal axis (which can include the pitch axis of the downstream stator blade), and secondly, the chord of the reference section of the downstream stator blade. The angle can be measured on the upstream side of the plane perpendicular to the longitudinal axis. The angle can be measured positively in a direction from the first axis to the chord of the reference section, and more particularly in a direction coinciding with the direction from the lower surface line to the upper surface line.

One of the downstream stator blades can be said to be “closed pitch” relative to another of the downstream stator blades when it has a pitch angle less than the pitch angle of the other downstream stator blade, preferably by at least 0.1°, more preferably by at least 1°. One of the downstream stator blades can be said to be “open pitch” relative to another of the downstream stator blades when it has a pitch angle greater than the pitch angle of the other downstream stator blade, preferably by at least 0.1°, more preferably by at least 1°.

Regardless of the mounting configuration of each of the downstream stator blades, the face of the lower surface and the face of the upper surface can be positioned in the same direction in the circumferential direction with respect to each other.

Each downstream stator blade can be pivotally mounted about a respective pitch axis which extends in a direction which includes at least a radial component. The aeronautical thruster can further comprise means for independently or together driving each of the downstream stator blades in rotation about the respective pitch axis. For example, the aeronautical thruster can comprise means for driving together each of the downstream stator blades arranged in an angular sector about the longitudinal axis in rotation about the respective pitch axis. In particular, each downstream stator blade can be connected at its radially inner end to a pitch arm which is adapted to rotate about the pitch axis of the downstream stator blade.

The reference section of each downstream stator blade can be located at the radially inner end of the downstream stator blade. Alternatively, the reference section of each downstream stator blade can be located, on the corresponding downstream stator blade, at a radial distance from the longitudinal axis which corresponds to 75% of the radially outer radius of the corresponding downstream stator blade. Alternatively, the reference section of each downstream stator blade can be located, on the downstream stator blade, at a distance radial to the longitudinal axis that corresponds to 75% of the radially outer radius of the downstream stator blade that has the minimum radially outer radius among the annular row of downstream stator blades.

Two downstream stator blades can have a different pitch angle. The difference between the pitch angle of two downstream stator blades can be less than 120°, preferably less than 60°. In particular, two circumferentially consecutive downstream stator blades can have a different pitch angle. The difference between the pitch angle of two downstream stator blades can be less than 45°, preferably less than 20°.

The pitch angle of each downstream stator blade can be determined as a function of the angular position of the downstream stator blade about the longitudinal axis according to a linear, parabolic, logarithmic, sinusoidal or exponential law.

Each downstream stator blade can have a different pitch angle to the pitch angle of the circumferentially adjacent downstream stator blade(s). This allows the flow incidence perceived by each downstream stator blade to be adapted locally, as well as reducing the correlation of noise sources and thus reducing the noise level emitted by the aeronautical thruster. Each downstream stator blade can have a different pitch angle from the pitch angle of the other downstream stator blades.

The aeronautical thruster can comprise between 2 and 25 upstream rotor blades. The thruster can comprise between 2 and 25 downstream stator blades.

The number of upstream rotor blades can be different from the number of downstream stator blades. This reduces the number of upstream rotor blades that are simultaneously positioned circumferentially around the longitudinal axis longitudinally opposite one of the downstream stator blades. This reduces the number of upstream rotor blade wakes that interact simultaneously with the downstream stator blades. The noise emitted by the propeller is then reduced. In particular, the number of upstream rotor blades can be greater than the number of downstream stator blades. Each downstream stator blade is a source of noise emission, and so a reduced number of downstream stator blades further reduces the noise level emitted by the thruster.

The strength of the annular row of downstream stator blades, defined as the ratio of the chord to the spacing in the circumferential direction between two circumferentially consecutive downstream stator blades, can be less than or equal to 3 over the entire radial dimension of each downstream stator blade. In particular, in a preferred embodiment, the strength is less than or equal to 1 at a radially outer end of each downstream stator blade.

Similarly, the strength of the annular row of upstream rotor blades, defined as the ratio of the chord to the spacing in the circumferential direction between two circumferentially consecutive upstream rotor blades, can be less than or equal to 3 over the entire radial dimension of each upstream rotor blade. In particular, in a preferred embodiment, the strength is less than or equal to 1 at a radially outer end of each upstream rotor blade.

The ratio between, firstly, the distance in the longitudinal direction separating a median plane of the upstream annular row of rotor blades and a median plane of the downstream annular row of stator blades, and, secondly, the diameter of the aeronautical thruster can vary between 0.01 and 0.8, preferably between 0.1 and 0.5. The median plane of each annular row of blades can be normal to the longitudinal axis. The median plane of each annular row of blades can be the plane containing the pitch axis of each of the blades in the corresponding annular row. Alternatively, the median plane of each annular row of blades can be the plane containing the pitch axis of at least one of the blades of the corresponding annular row. The diameter of the aeronautical thruster can be defined as twice the radially outer radius of the upstream propeller. The trailing edge of each of the blades in the upstream annular row is located longitudinally upstream of a leading edge of each of the blades in the downstream annular row. This limits or even avoids interference between annular rows of blades.

The hub can be axisymmetric about the longitudinal axis.

The downstream stator blades of the annular row of downstream stator blades that are located around the longitudinal axis in a first angular sector around the longitudinal axis can each be in the closed-pitch configuration relative to at least one downstream stator blade of the annular row of downstream stator blades that is located around the longitudinal axis in a second angular sector around the longitudinal axis, the second angular sector being distinct from the first angular sector.

The annular row of downstream stator blades can comprise at least two circumferentially consecutive downstream stator blades in each of the first angular sector and the second angular sector. This allows a significant shimming effect on at least the two circumferentially consecutive blades, which will interact with a flow having similar characteristics (incidence, velocity, . . . ).

At least two downstream stator blades each arranged in the first sector can have identical dimensional characteristics. In other words, at least two downstream stator blades, each arranged in the first sector, can have an identical aerodynamic profile. It is understood that for each section of one of the two downstream stator blades, there is a corresponding section of the other of the two downstream stator blades which is arranged at the same radial distance from the longitudinal axis and has the same aerodynamic profile.

The downstream stator blades of the annular row of downstream stator blades that are located around the longitudinal axis in a first angular sector around the longitudinal axis can each be in the closed-pitch configuration relative to each of the downstream stator blades of the annular row of downstream stator blades that are located around the longitudinal axis in the second angular sector around the longitudinal axis.

The first angular sector can extend over an angular range of less than or equal to 180°, preferably less than or equal to 120°, or more preferably less than or equal to 90°.

The first angular sector can be centred on an angular position at 12H. Such an arrangement makes it easier to circumvent the air flow around a structural element of an aircraft on which is mounted the aeronautical thruster which is located close to the aeronautical thruster at the level of the angular position at 12H (for example a wing of the aircraft on which the aeronautical thruster is mounted or the mast in an installation under the wing of the aircraft). This also reduces pressure distortion rise between the structural member and the downstream stator blades, and avoids boundary layer separation and the formation of recirculation zones on the downstream stator blades which would increase aerodynamic losses and noise levels.

The first angular sector can be centred on an angular position at 3H or at 9H. Such an arrangement facilitates the bypassing of airflow around a structural member of an aircraft on which the aeronautical thruster is mounted which is located in the vicinity of the aero-thruster at the angular position at 3H, respectively at 9H (e.g, the fuselage of the aircraft on which the aeronautical thruster is mounted, the angular position at 3H or 9H depending on the side of the aircraft fuselage with respect to which the aeronautical thruster is mounted, or the mast in an installation of the aeronautical thruster at the rear of the aircraft). This also reduces pressure distortion rise between the structural member and the downstream stator blades, and avoids boundary layer separation and the formation of recirculation zones on the downstream stator blades which would increase aerodynamic losses and noise levels.

Such a configuration also reduces the level of noise emitted by the aeronautical thruster towards an angular position at 6H (i.e. towards the ground).

Noise from the interaction between the wake of the upstream rotor blades and the downstream stator blades produces “dipole” type acoustic radiation from the downstream stator blades. Therefore, the interaction noise radiated by the downstream stator blades is not axisymmetric around the longitudinal axis and depends on the circumferential position of the downstream stator blades around the longitudinal axis. Thus, the directivity of the noise emitted by the downstream stator blades located in the first angular sector is different to the directivity of the noise emitted by the other downstream stator blades. This reduces the noise in a free field direction corresponding to the first angular sector.

The first angular sector can be centred on an angular position at 6H. Such a configuration reduces the level of noise emitted by the aeronautical thruster towards an angular position at 3H and an angular position at 9H (i.e. towards the cabin of an aircraft on which the aeronautical thruster is mounted).

The downstream stator blades of the annular row of downstream stator blades located around the longitudinal axis in a first angular sub-sector of the second angular sector around the longitudinal axis can each be in the open-pitch configuration relative to the downstream stator blades located around the longitudinal axis in a second angular sub-sector of the second angular sector around the longitudinal axis, the second angular sub-sector being distinct from the first angular sub-sector.

The first angular sub-sector can extend over an angular range of less than or equal to 180°, preferably less than or equal to 120°, more preferably less than or equal to 90°.

The first angular sector can be centred on one of the angular positions at 3H and 9H and the first angular sub-sector can be centred on the other of the angular positions at 3H and 9H. The upstream rotor blades can be driven in a direction of rotation about the longitudinal axis such that the upstream rotor blades which are located in the first angular sector are rotated about the longitudinal axis in a direction from an angular position at 6H to an angular position at 12H and the upstream rotor blades which are located in the first angular sub-sector are rotated about the longitudinal axis in a direction from the angular position at 12H to the angular position at 6H. Thus, the upstream rotor blades are said to be “rising” when they are located in the first angular sector in that they are driven towards the angular position at 12H and the upstream rotor blades are said to be “falling” when they are located in the first angular sub-sector in that they are driven towards the angular position at 6H.

Such a configuration of the downstream annular row ensures that the downstream stator blades located respectively in the first angular sector and the first angular sub-sector are subjected to a similar aerodynamic load despite the different wakes of the upstream rotor blades depending on whether the upstream rotor blades are located in the first angular sector or the first angular sub-sector, this is the result of forces exerted on the upstream rotor blades which depend on their position about the longitudinal axis during their rotation about the longitudinal axis, in particular during the phases of operation of the aeronautical thruster at incidence, for example during the landing and take-off phases.

The first angular sector can be centred on one of the angular positions at 12H and 6H and the first angular subsector can be centred on the other of the angular positions at 12H and 6H. Such a configuration of the downstream annular row ensures that the downstream stator blades located in the first angular sector and the first angular sub-sector respectively are subject to a similar aerodynamic load when the airflow incident on the downstream annular row of stator blades has a non-zero incidence with respect to the longitudinal axis, e.g. in a crosswind.

The downstream stator blades of the annular row of downstream stator blades located around the longitudinal axis in a first angular sub-sector of the second angular sector around the longitudinal axis can each be in the open-pitch configuration relative to the downstream stator blades located around the longitudinal axis in a second angular sub-sector of the second angular sector around the longitudinal axis, the second angular sub-sector being distinct from the first angular sub-sector.

The first angular sub-sector can extend over an angular range of less than or equal to 180°, preferably less than or equal to 120°, more preferably less than or equal to 90°.

The first angular sector can be centred on an angular position at 9H and the first angular sub-sector can be centred on an angular position at 3H. Such a configuration also reduces the level of noise emitted by the aeronautical thruster towards an angular position at 6H (i.e. towards the ground).

The first angular sector can be centred on one of the angular positions at 12H and 6H and the first angular subsector can be centred on the other of the angular positions at 12H and 6H. Such a configuration reduces the level of noise emitted by the aeronautical thruster towards an angular position at 3H and an angular position at 9H (i.e. towards the cabin of an aircraft on which the aeronautical thruster is mounted).

Each of the downstream stator blades located around the longitudinal axis in the first angular sector or in the second angular sector, or if applicable in the first angular sub-sector of the second angular sector or in the second angular sub-sector of the second angular sector, can have an identical pitch angle within 1°.

At least two downstream stator blades located around the longitudinal axis in the first angular sector or in the second angular sector, or possibly in the first angular sub-sector of the second angular sector or in the second angular sub-sector of the second angular sector, can have identical dimensional characteristics.

At least two downstream stator blades located around the longitudinal axis in the first angular sector or in the second angular sector, or possibly in the first angular subsector of the second angular sector or in the second angular subsector of the second angular sector, can have different dimensional characteristics.

For each pair of a first downstream stator blade and a second downstream stator blade, each section of the first downstream stator blade can have an identical aerodynamic profile to a corresponding section of the second downstream stator blade over an upstream end portion that extends longitudinally over a relative chord length of between 5% and 50%, preferably between 10% and 30%, said corresponding sections of the first downstream stator blade and the second downstream stator blade each being disposed at the same radial distance from the longitudinal axis.

In another aspect, a propulsion system is proposed comprising an aeronautical thruster as described above and a pylon adapted to attach the aeronautical thruster to a fuselage or wing of the aircraft, the pylon extending in a direction including at least a radial direction from a radially inner end by which it is connected to the propulsion unit hub, the pylon comprising a leading edge and a trailing edge between which extend on each side in the circumferential direction a upper surface face and a lower surface face, the upper surface face and the lower surface face of the pylon being, at least on an upstream part of the pylon circumferentially disposed on either side of a radial plane defined by the longitudinal axis and a radial axis passing, at least in part, through the leading edge of the pylon, and wherein the annular row of downstream stator blades of the aeronautical thruster can comprise:
a first group comprising one or more downstream blade(s) which each have a downstream end located circumferentially on the same side as the upper surface face of the pylon with respect to the radial plane, the first group comprising at least the downstream stator blade which is circumferentially closest to the radial plane and whose downstream end is located circumferentially on the same side as the upper surface face of the pylon with respect to the radial plane,
a second group comprising one or more downstream blades which each have a downstream end located circumferentially on the same side as the pressure face of the pylon with respect to the radial plane, the second group comprising at least the downstream stator blade which is circumferentially closest to the radial plane and whose downstream end is located circumferentially on the same side as the pressure face of the pylon with respect to the radial plane.

Each downstream stator blade of the first group can be in a closed-pitch configuration relative to each downstream stator blade of the second group.

Such a configuration of the downstream annular row ensures that the downstream stator blades of the first group and the downstream stator blades of the second group are subjected to a relatively similar aerodynamic load despite airflow conditions at the downstream stator blade annular row being different on either side of the radial plane due to the presence of the pylon.

Such an arrangement facilitates flow bypass around the pylon, thereby reducing pressure distortion rise between the pylon and the downstream stator blades of the first type, and avoiding boundary layer separation and the formation of recirculation zones on the downstream stator blades of the first type which would increase aerodynamic losses and noise levels.

The “lower surface face” and “upper surface face” of the pylon means the end faces of the pylon in the circumferential direction, which are positioned in the same direction in the circumferential direction as the lower and upper surface faces of each of the downstream stator blades. The pylon can have a shape that does not have an aerodynamic profile.

In other words, each downstream stator blade of the second group is in an open-pitch configuration relative to each downstream stator blade of the first group.

The pylon can be positioned around the axis of rotation at an angular position at 12H or 6H around the longitudinal axis of the aeronautical thruster. Such a configuration allows the aeronautical thruster to be attached to or under the aircraft's wing. The pylon can be positioned around the axis of rotation at an angular position at 3H or 9H around the longitudinal axis of the aeronautical thruster. Such a configuration allows the aeronautical thruster to be attached to a rear part of an aircraft fuselage.

The pylon can be arranged longitudinally, in whole or in part, downstream of the annular row of downstream stator blades. The pylon can be arranged circumferentially, in whole or in part, between two circumferentially adjacent downstream stator blades of the first type.

The downstream stator blades of the first group can be circumferentially consecutive two by two and/or the downstream stator blades of the second group are circumferentially consecutive two by two.

In another aspect, an aircraft is proposed comprising an aeronautical thruster as described above or a propulsion system as described above.

In another aspect, a method of operating the aeronautical thruster as described above or the propulsion system as described above is proposed, the method comprising adjusting the pitch angle of each downstream stator blade in accordance with an incidence phase of operation of the aeronautical thruster.

A phase of impact operation can be characterised by one or more of the following features:
a Mach of advancement of the propulsion system between 0 and 0.4;
the propulsion system comprises a high lift device (slat, flap) in an at least partially deployed state;
the altitude of the propulsion system is less than or equal to 5000 m;
the slope of the trajectory of the propulsion system is between −1° and −10° (landing incidence phase) or between 1° and 20° (take-off incidence phase);
the propulsion system is attached to an aircraft whose angle of attack (i.e. the angle between the forward speed and the main axis of an aircraft fuselage) is between 0° and 10° (landing incidence phase) or between 0° and 15° (take-off incidence phase).

The method can include sensing one or more of the foregoing characteristics and transmitting the characteristic(s) as data to a digital control system (e.g. an interface between a cockpit and the engine, known as “Full Authority Digital Engine Control”, also known as “FADEC”). The determination of the pitch angle of each downstream stator blade of the second type can be achieved by servo-control of said data, in particular by the digital control system.

### BRIEF DESCRIPTION OF THE DRAWINGS

Further features, details and benefits will emerge from reading the detailed description below, and from the analysis of the attached drawings, on which:

FIG. 1 is a partial schematic cross-sectional view of an unducted fan turbomachine according to the prior art;

FIG. 2 is a partial schematic view of an unducted fan turbomachine according to the present description;

FIG. 3 includes FIG. 3a which is a schematic view of a downstream stator blade of the turbomachine of FIG. 2 and FIG. 3b which is a schematic view of the downstream stator blade of FIG. 3a in section plane III-III;

FIG. 4 is a schematic cross-sectional view of an annular row of downstream stator blades of the turbomachine of FIG. 2 in a first configuration;

FIG. 5 is a schematic cross-sectional view of an annular row of downstream stator blades of the turbomachine of FIG. 2 in a second configuration;

FIG. 6 is a schematic cross-sectional view of an annular row of downstream stator blades of the turbomachine of FIG. 2 in a third configuration;

FIG. 7 comprises FIGS. 7a and 7b which are respectively a schematic cross-sectional view of an annular row of downstream stator blades of the turbomachine of FIG. 2 according to a fourth configuration and a graph illustrating the fourth configuration of the annular row of downstream stator blades;

FIG. 8 comprises FIGS. 8a and 8b which are respectively a schematic cross-sectional view of an annular row of downstream stator blades of the turbomachine of FIG. 2 according to a fifth configuration and a graph illustrating the fifth configuration of the annular row of downstream stator blades;

FIG. 9 comprises FIGS. 9a and 9b which are each a schematic cross-sectional view of an annular row of downstream stator blades of the turbomachine of FIG. 2 according to a respective variant of a sixth configuration;

FIG. 10 comprises FIGS. 10a and 10b, each of which is a schematic cross-sectional view of an annular row of downstream stator blades of the turbomachine of FIG. 2 in a respective variant of a seventh configuration;

FIG. 11 is a circumferentially extended schematic partial view of an eighth configuration of the annular row of downstream stator blades of the turbomachine of FIG. 2.

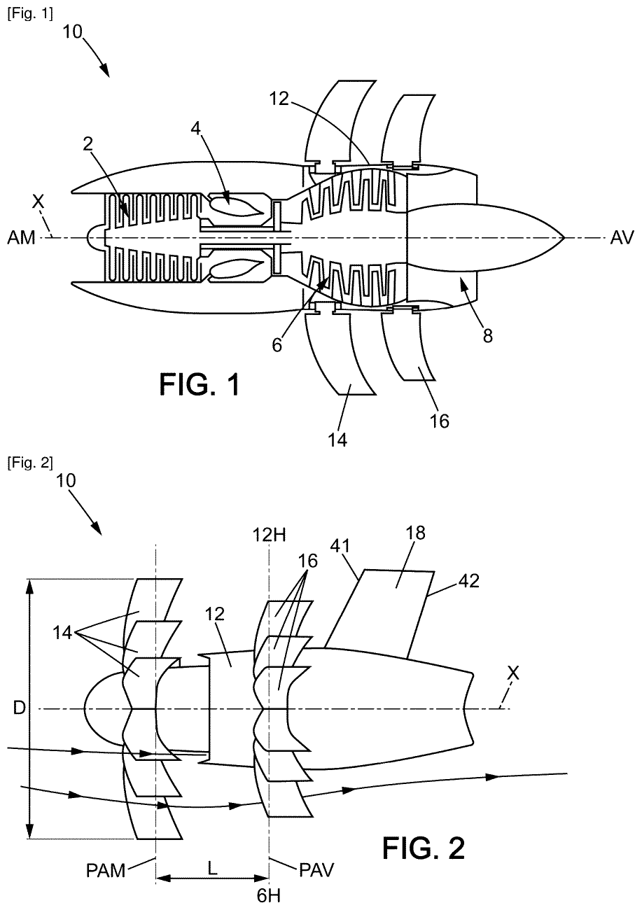

### DESCRIPTION OF THE EMBODIMENTS

Reference is now made to FIG. 2. FIG. 2 shows a propulsion system for an aircraft which comprises a turbomachine 10 of longitudinal axis X and a pylon 18 adapted to attach the turbomachine 10 to the aircraft, here at a wing of the aircraft. Alternatively, the pylon 18 can be adapted to attach the turbomachine 10 to a fuselage, in particular aft, of the aircraft. As before, orientation qualifiers such as “longitudinal”, “radial” or “circumferential” are defined with reference to the longitudinal axis X of the turbomachine 10. The relative terms “upstream” and “downstream” are defined in relation to each other with reference to the flow of gases in the turbomachine 10 along the longitudinal axis X.

The turbomachine 10 comprises a hub 12. The hub 12 is here axisymmetric about the longitudinal axis X. The turbomachine 10 machine further comprises an annular row of unducted upstream rotor blades 14 and an annular row of unducted downstream stator blades 16. The annular row of upstream rotor blades 14 and the annular row of downstream stator blades 16 are spaced apart from each other along the longitudinal axis X. The term “unducted” used in reference to the upstream rotor blades 14 and the downstream stator blades 16 indicates that the upstream rotor blades 14 and the downstream stator blades 16 are not surrounded by a basket, in contrast to conventional turbomachines 10 in which the fan is ducted within a basket.

The annular row of upstream rotor blades 14 is rotatable about the longitudinal axis X. The annular row of downstream stator blades 16, which are unducted, is prevented from rotating about the longitudinal axis X. The annular row of downstream stator blades 16 is therefore fixed about the longitudinal axis X. In other words, the downstream stator blades 16 are not rotated about the longitudinal axis X. The annular row of upstream rotor blades 14 and the annular row of downstream stator blades 16 define an upstream propeller and a downstream propeller respectively.

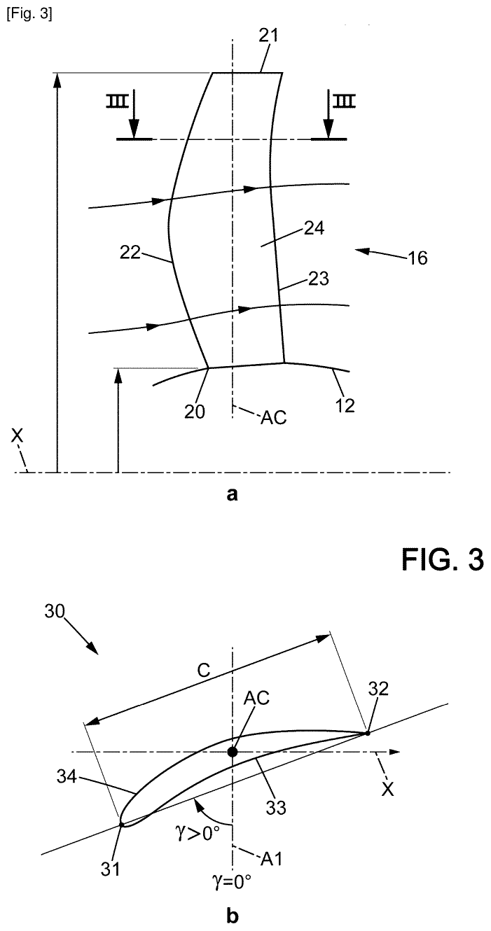

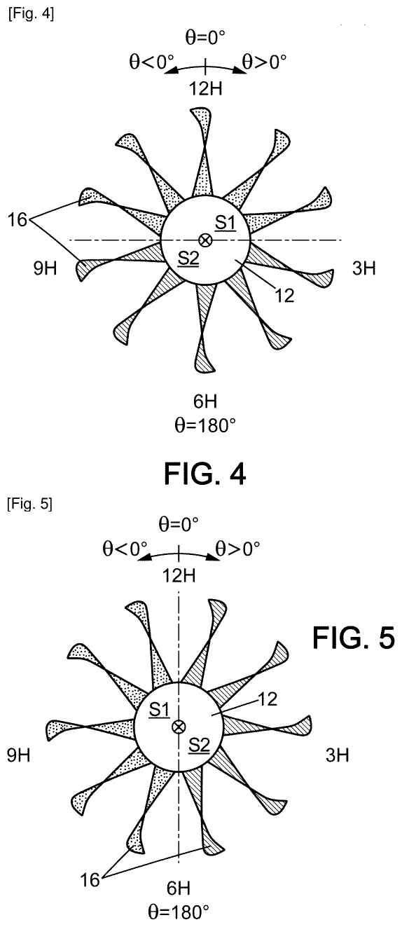

FIG. 4 shows the annular row of downstream stator blades 16 in a first configuration and FIG. 3 shows one of the downstream stator blades 16 in more detail. Each downstream stator blade extends radially between a radially inner end 20, this being located at (i.e. closest to) the hub 12 of the turbomachine 10, and a radially outer end 21. In the example shown, the radially inner end 20 is longitudinally at a leading edge 22 of the blade. The radially inner end 20 is also called the “root” of the blade. The position of each blade about the longitudinal axis X as considered hereafter is marked by the position about the longitudinal axis X of the radially inner end 20 of the respective blade. The radially outer end 21 of each downstream stator blade 16 is the opposite end to the radially inner end 20 of the blade. The radially outer end 21 is the free end of the downstream stator blade 16.

The position of each of the downstream stator blades 16 about the longitudinal axis X is expressed as an angular position about the longitudinal axis X. The angular position of each of the downstream stator blades 16 is referenced to a time dial (here considered from upstream for example) whose angular positions at 12H, 3H, 6H and 9H are conventionally positioned. The angular position at 12H is therefore positioned vertically upwards with respect to the longitudinal axis X. The angular position at 6H is positioned vertically downwards with respect to the longitudinal axis X. The angular position at 3H is positioned horizontally to the right with respect to the longitudinal axis X. The angular position at 9H is positioned horizontally to the left with respect to the longitudinal axis X. An axis extending radially through the angular positions at 12H and 6H is thus perpendicular to an axis extending radially through the angular positions at 3H and 9H. Qualifiers of absolute position, such as the terms “top”, “bottom”, “left”, “right”, etc., or of relative position, such as the terms “above”, “below”, “upper”, “lower”, etc., and the orientation qualifiers, such as the terms “vertical” and “horizontal” can be considered in an operational state of the turbomachine 10, typically when the latter is installed on an aircraft on the ground. In this state of the turbomachine 10, the axis through the angular positions at 12H and 6H extends in the direction of the gravity field, i.e. vertically.

The angular position of each downstream stator blade 16 is also defined by an angle θ measured around the longitudinal axis X positively clockwise from the angular position at 12H. For example, for each downstream stator blade 16, the angle θ can be measured between an axis perpendicular to the longitudinal axis X of the turbomachine 10 passing through the radially inner end 20 (or radially outer end 21) of the downstream stator blade 16 and the axis passing through the angular positions at 12H and 6H. Thus, the angular position of a downstream stator blade 16 located at the angular position at 12H is defined by an angle θ equal to 0°, the angular position of a downstream stator blade 16 located at the angular position at 3H is defined by an angle θ equal to 90°, the angular position of a downstream stator blade 16 located at the angular position at 6H is defined by an angle θ equal to 180° (or equivalently −180° and the angular position of a downstream stator blade 16 located at the angular position at 9H is defined by an angle θ equal to 270° (or equivalently −90°.

Each downstream stator blade 16 has a radially outer radius. The radially outer radius of a blade is the radial distance to the longitudinal axis X of the radially outer end 21 of the blade. In other words, it is the maximum radius of the blade. In the example shown, each downstream stator blade 16 has an identical radially outer radius which thus corresponds to the radially outer radius of the downstream propeller.

Each downstream stator blade 16 defines an aerodynamic profile. For this purpose, each downstream stator blade 16 comprises a stack of sections 30 in the radial direction. One of the sections 30 is shown in FIG. 3b. Each section 30 extends in a respective section plane which is perpendicular to the radial direction of extension of the corresponding downstream stator blade 16. Each section 30 comprises a leading edge 31 upstream and a trailing edge 32 downstream between which extend a lower surface line 33 and an upper surface line 34. Each section 30 defines an aerodynamic profile. Each section 30 also includes a chord C defined by a straight line portion connecting the leading edge 31 to the trailing edge 32.

The leading edge 31 and the trailing edge 32 of all the sections 30 in the stack of sections 30 form, for each downstream stator blade 16, a leading edge 22 and a trailing edge 23 of the blade respectively. Similarly, the lower surface line 33 and the upper surface line 34 of the set of sections 30 of the stack of sections 30 respectively form, for each downstream stator blade 16, a lower surface face 24 (visible in FIG. 3a) and an upper surface face (not visible in FIG. 3a) of the downstream stator blade 16.

In the following illustrated examples, each downstream stator blade 16 has identical dimensional characteristics. In other words, each downstream stator blade 16 has an identical aerodynamic profile. It is therefore understood that for each section 30 of one of the downstream stator blades 16, there is a corresponding section 30 of another of the downstream stator blades 16 which is arranged at the same radial distance from the longitudinal axis and has the same aerodynamic profile. In a variant not shown, at least two downstream stator blades 16 can have different dimensional characteristics. In other words, at least two downstream stator blades 16 can have a different aerodynamic profile from each other.

Each downstream stator blade 16 has a respective AC pitch axis. As can be seen in FIG. 3a, the AC pitch axis of each downstream stator blade 16 here lies in a plane perpendicular to the longitudinal axis X. In particular, the AC pitch axis of each downstream stator blade 16 extends radially in the illustrated example.

As shown in FIG. 3b, the pitch angle γ of each downstream stator blade 16 corresponds to the angle formed, firstly, between a first axis A1 which is defined by the intersection between the section plane of a reference section 30 among the stack of sections 30 of the downstream stator blade 16 and a plane perpendicular to the longitudinal axis X which includes the AC pitch axis of the downstream stator blade 16, and secondly, the chord C of the reference section 30 of the downstream stator blade 16. The pitch angle γ is measured on the upstream side of the plane perpendicular to the longitudinal axis X which includes the AC pitch axis of the downstream stator blade 16. The pitch angle γ is measured positively along a direction going from the first axis A1 to the chord C of the reference section 30, and more particularly in a direction coinciding with the direction going from the lower surface line 33 towards the upper surface line 34.

The reference section 30 of each downstream stator blade 16 is located here, on the corresponding downstream stator blade 16, at a radial distance to the longitudinal axis X which corresponds to 75% of the radially outer radius of the corresponding downstream stator blade 16.

In the following, a first downstream stator blade 16 is said to be “closed pitch” relative to a second downstream stator blade 16 when it has a pitch angle γ smaller than the pitch angle γ of the second downstream stator blade 16. Conversely, a first downstream stator blade 16 is said to be “open pitch” relative to a second downstream stator blade 16 when it has a pitch angle γ greater than the pitch angle γ of the second downstream stator blade 16.

Whatever the setting configuration of each of the downstream stator blades 16, the lower surface face 24 and the upper surface face are, for each of the downstream stator blades 16, positioned relative to each other according to the same direction in the circumferential direction.

The strength of the annular row of downstream stator blades 16, defined as the ratio between the chord C, and the spacing in the circumferential direction between two circumferentially consecutive downstream stator blades 16, may be less than or equal to 3 over the whole of the radial dimension of each downstream stator blade 16. In particular, in a preferred embodiment, the strength is less than or equal to 1 at the level of a radially outer end 21 of each downstream stator blade 16.

The ratio between, firstly, the distance L in the longitudinal direction separating a median plane PAM of the annular row of upstream rotor blades 14 and a median plane PAV of the annular row of downstream stator blades, and, secondly, the diameter D of the turbomachine 10 can vary between 0.01 and 0.8, preferably between 0.1 and 0.5. The median plane PAM, PAV of each annular row of blades is here normal to the longitudinal axis X. The median plane PAM, PAV of each annular row of blades is the plane containing the AC pitch axis of each of the blades of the corresponding annular row. The diameter D of the turbomachine 10 corresponds here to the diameter of the upstream propeller. The trailing edge of each of the blades of the upstream annular row 14 is located longitudinally upstream of a leading edge 22 of each of the blades of the downstream annular row 16. Thus, interference between the annular rows of blades is limited, or even avoided.

The pylon 18 has a radially inner end 20 through which it is connected to the hub 12 of the turbomachine 10. The pylon 18 extends generally radially in that it extends in a direction comprising at least a radial component. It is not excluded that the pylon 18 extends in a direction that also includes a longitudinal and/or circumferential component. In the example shown in FIG. 2, the pylon extends in a direction comprising a radial and a longitudinal component. The pylon 18 comprises a leading edge 41 and a trailing edge 42, between which an upper surface face 44 and an lower surface face 43 extend on each side in the circumferential direction. The upper surface face 44 and the lower surface face 43 of the pylon 18 are, at least on an upstream part of the pylon 18, arranged circumferentially on each side of a radial plane defined by the longitudinal axis X and a radial axis passing through the leading edge 41 of the radially inner end of the pylon 18. In the example shown, the pylon 18 has an aerodynamic profile.

In the example shown in FIG. 2, the pylon 18 is positioned about the axis of rotation at an angular position at 12H about the longitudinal axis X of the turbomachine 10. Such a configuration allows the turbomachine 10 to be mounted under the wing of the aircraft. Also, the pylon 18 is arranged longitudinally downstream of the annular row of downstream stator blades 16.

Each downstream stator blade 16 has a variable pitch. Each downstream stator blade 16 can thus be rotated around its pitch axis AC to change the angle of incidence of the air flow on the downstream stator blade 16. In addition, at least one of the downstream stator blades 16 is in a closed-pitch configuration relative to another of the downstream stator blades 16. The rotational adjustment of each downstream stator blade 16 about the respective AC pitch axis can then be carried out as a function of the incidence of the turbomachine 10 which varies according to the phase of operation at incidence (for example landing phase and/or take-off phase), and/or as a function of the airflow conditions taken locally at the level of the downstream stator blade 16, these can depend, depending on the position of the downstream stator blade 16 around the longitudinal axis X, on the wake of the upstream rotor blades 14 and/or on the presence of structural elements of an aircraft on which the turbomachine 10 is mounted (mast, fuselage, wing, slat, flaps, tailplane, etc.). This makes it possible, firstly, to reduce the level of noise emitted by the turbomachine 10, and secondly, to improve the aerodynamic performance of the annular row of downstream stator blades 16.

To this end, each downstream stator blade 16 can be pivotally mounted about a respective AC pitch axis, which here extends in a radial direction, to change the angle of incidence of the airflow on each downstream stator blade 16. The turbomachine 10 can further comprise means for independently or together driving each of the downstream stator blades 16 in rotation about the respective pitch axis AC. For example, the turbomachine 10 may comprise means for driving together each of the downstream stator blades 16 arranged in an angular sector around the longitudinal axis X in rotation around the respective pitch axis AC. These means can be arranged radially inside the hub 12. In particular, each downstream stator blade 16 can be connected, at its radially inner end, to a wedging arm which is adapted to rotate around the wedging axis AC of the downstream stator blade 16.

According to the first configuration of the annular row of downstream stator blades 16, the downstream stator blades 16 of the annular row of downstream stator blades 16 that are located about the longitudinal axis X in a first angular sector S1 about the longitudinal axis X are each rotated about the respective AC pitch axis so as to be in the closed-pitch configuration relative to at least one downstream stator blade 16 of the annular row of downstream stator blades 16 that is located about the longitudinal axis X in a second angular sector S2 about the longitudinal axis X. The second angular sector S2 is distinct from the first angular sector S1. Here the first angular sector S1 and the second angular sector are complementary in that they extend over angular ranges whose sum is equal to 360°.

In particular, in the first configuration, the downstream stator blades 16 out of the annular row of downstream stator blades 16 that are located in the first angular sector S1 about the longitudinal axis X are each in the closed-pitch configuration relative to each of the downstream stator blades 16 out of the annular row of downstream stator blades 16 that are located about the longitudinal axis X in the second angular sector S2 about the longitudinal axis X.

According to the first configuration, the first angular sector S1 extends over an angular range equal to 180°. The first angular sector S1 is advantageously centred on the angular position at 12H. Such an arrangement facilitates the bypassing of airflow around a structural member of an aircraft on which the turbomachine 10 is mounted that is located in close proximity to the turbomachine 10 at the angular position at 12H (for example a wing of the aircraft on which the turbomachine 10 is mounted). This reduces the interaction with the airflow around a structural member of an aircraft on which the turbomachine 10 is mounted which is located in close proximity to the turbomachine 10 at the angular position at 12H. This also reduces pressure distortion rise between the structural member and the downstream stator blades 16, and avoids boundary layer separation and the formation of recirculation zones on the downstream stator blades 16 which would increase aerodynamic losses and noise levels.

FIG. 5 shows a second configuration of the annular row of downstream stator blades 16. The second configuration differs from the first configuration in that the first angular sector S1 is advantageously centred on the angular position at 9H. Such an arrangement facilitates the bypassing of airflow around a structural member of an aircraft on which the turbomachine 10 is mounted which is located in close proximity to the turbomachine 10 at the angular position at 9H (for example the fuselage of the aircraft on which the turbomachine 10 is mounted). This also reduces pressure distortion rise between the structural member and the downstream stator blades 16, and avoids boundary layer separation and the formation of recirculation zones on the downstream stator blades 16 which would increase aerodynamic losses and noise levels. Such a configuration further reduces the noise level emitted by the turbomachine 10 in the direction of the angular position at 6H (i.e. towards the ground) in that it has been found that a closed-pitch configuration reduces the noise level emitted by the blade.

In an alternative embodiment not shown, the first sector can be centred on the angular position at 3H to achieve a similar effect when the aircraft structural member (in particular the fuselage) is located in proximity to the turbomachine 10 at the angular position at 9H (the angular position at 3H or 9H depending on which side of the aircraft fuselage the turbomachine 10 is mounted relative to).

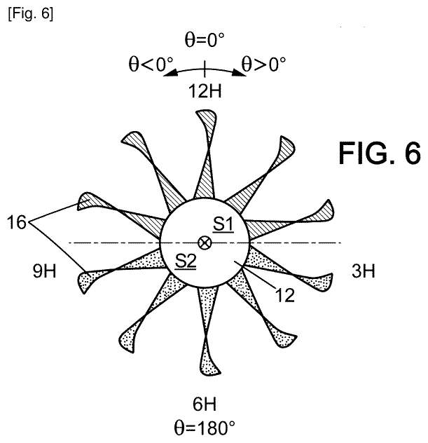

FIG. 6 shows a third configuration of the annular row of downstream stator blades 16. The third configuration differs from the first configuration and the second configuration in that the first angular sector S1 is advantageously centred on the angular position at 6H. Such a configuration reduces the level of noise emitted by the turbomachine 10 towards the angular position at 3H and the angular position at 9H (i.e. towards the cabin of an aircraft on which the turbomachine 10 is mounted) in that it has been found that a closed-pitch configuration reduces the level of noise emitted by the blade.

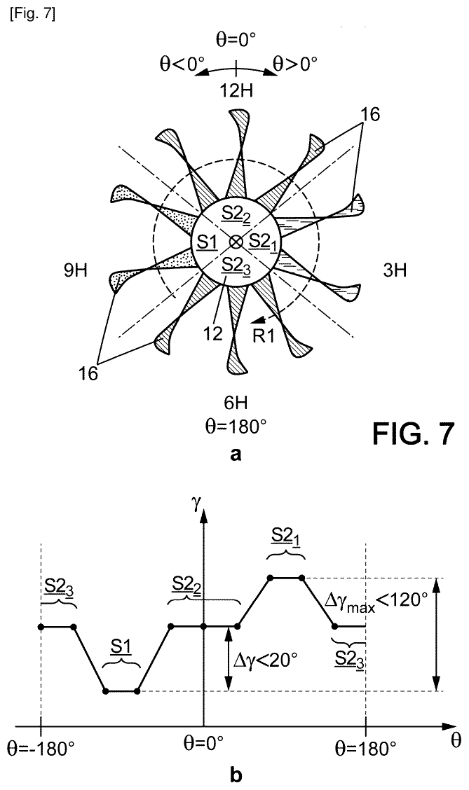

FIG. 7a shows a fourth configuration of the annular row of downstream stator blades 16. FIG. 7b is a graph showing the fourth configuration of the annular row of downstream stator blades 16. The graph shows the pitch angle γ of each of the downstream stator blades 16 as a function of the angle θ associated with the angular position of the blade. In the fourth configuration, the first angular sector S1 is centred on the angular position at 9H and extends over an angular range of less than 90°. The second angular sector S2 is centred on the angular position at 3H.

Furthermore, the downstream stator blades 16 of the annular row of downstream stator blades 16 that are located around the longitudinal axis X in a first angular sub-sector S2₁ of the second angular sector S2 around the longitudinal axis X are each rotated around the respective AC pitch axis so as to be in the open-pitch configuration relative to the downstream stator blades 16 located around the longitudinal axis X in a second angular sub-sector S2₂ of the second angular sector S2 around the longitudinal axis X. The second angular sub-sector S2₂ is distinct from the first angular sub-sector S2₁.

The downstream stator blades 16 of the annular row of downstream stator blades 16 that are located about the longitudinal axis X in the first angular sub-sector S2₁ are also each rotated about the respective pitch axis AC so as to be in the open-pitch configuration relative to the downstream stator blades 16 located about the longitudinal axis X in a third angular sub-sector S2₃ of the second angular sector S2 about the longitudinal axis X. The third angular sub-sector S2₃ is distinct from the first angular sub-sector S2₁ and the second angular sub-sector S2₂.

The first angular sub-sector S2₁ extends over an angular range of less than 90°. The second angular sub-sector S2₂ and the third angular sub-sector S2₃ each extend over an angular range greater than 90°.

The first angular sub-sector S2₁ is advantageously centred on the other of the angular positions at 3H. Furthermore, as shown in FIG. 7a, the upstream rotor blades 14 of the annular row of upstream rotor blades 14 are driven in a rotational direction R1 about the longitudinal axis X such that the upstream rotor blades 14 that are located in the first angular sector S1 are rotated about the longitudinal axis X in a direction from the angular position at 6H to the angular position at 12H and the upstream rotor blades 14 of the annular row of upstream rotor blades 14 that are located in the first sub-angular sector S2₁ are rotated about the longitudinal axis X in a direction from the angular position at 12H to the angular position at 6H. Such a configuration of the downstream annular row ensures that the downstream stator blades 16 located respectively in the first angular sector S1 and the first angular sub-sector S2₁ are subjected to a similar aerodynamic load despite different wakes of the upstream rotor blades 14 depending on whether the upstream rotor blades 14 are located in the first angular sector S1 or the first angular sub-sector S2₁, this is the result of forces exerted on the upstream rotor blades 14 which depend on their position about the longitudinal axis X during their rotation about the longitudinal axis X and during an incidence phase.

The second angular sub-sector S2₂ and the third angular sub-sector S2₃ are centred on the angular positions at 12H and 6H respectively.

The difference between the pitch angle γ of two downstream stator blades 16 is less than 120°, preferably less than 60°. In particular, two circumferentially consecutive downstream stator blades 16 can have a different pitch angle γ. The difference between the pitch angle γ of two circumferentially consecutive downstream stator blades 16 is less than 45°, preferably less than 20°.

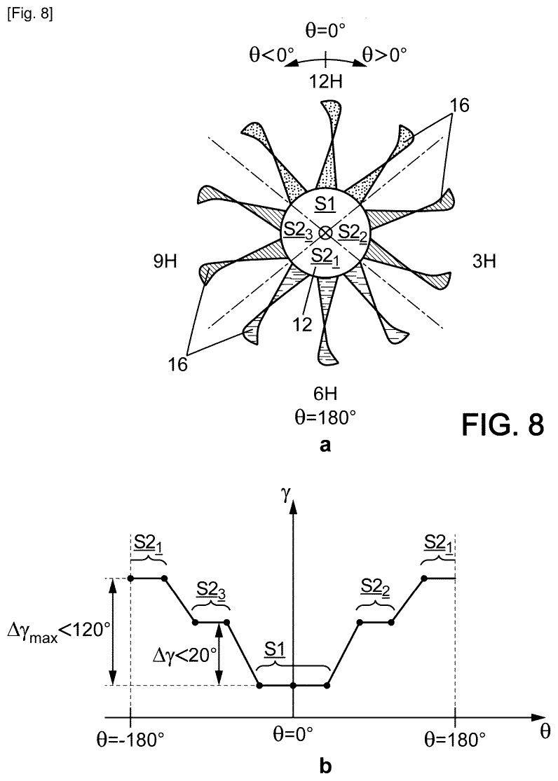

FIG. 8a shows a fifth configuration of the annular row of downstream stator blades 16. FIG. 8b is a graph showing the fifth configuration of the annular row of downstream stator blades 16. The graph represents the pitch angle γ of each of the downstream stator blades as a function of the angle θ associated with the angular position of the blade. The fifth configuration differs from the fourth configuration in that the first angular sector S1 is advantageously centred on an angular position at 12H and the first angular sub-sector S2₁ is advantageously centred on an angular position at 6H. Such a configuration of the downstream annular row ensures that the downstream stator blades 16 located respectively in the first angular sector S1 and the first angular subsector S2₁ are subjected to the same aerodynamic load when the airflow incident to the annular row of downstream stator blades 16 has a non-zero incidence with respect to the longitudinal axis X, for example in the presence of a crosswind.

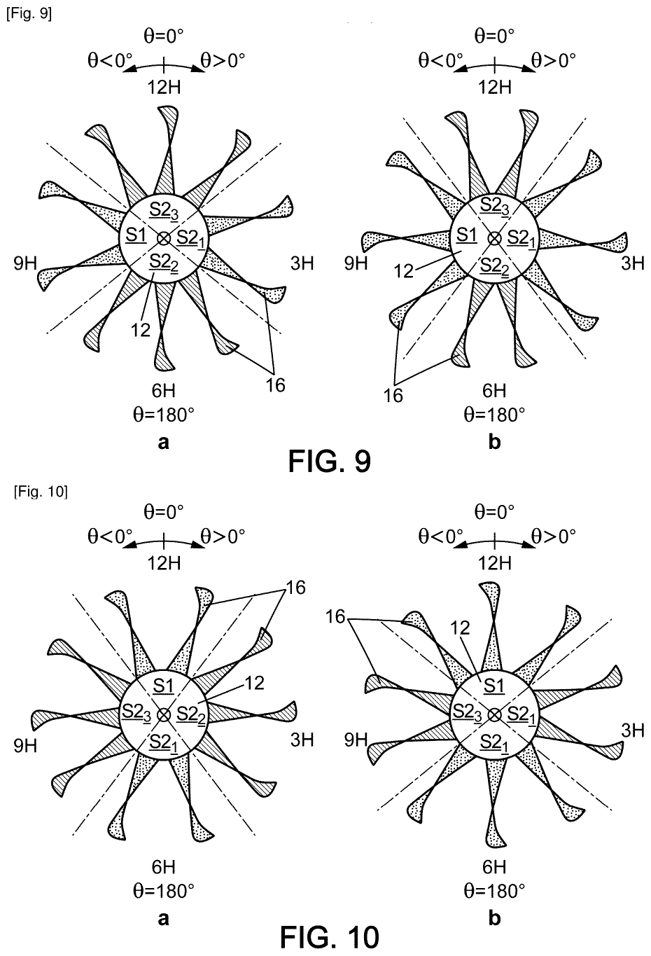

FIG. 9a shows a first variant of a sixth configuration of the downstream stator blade ring row 16. According to the first variant of the sixth configuration, the first angular sector S1 is centred on the angular position at 9H and extends over an angular range of less than 90°. The second angular sector S2 is centred on the angular position at 3H.

Furthermore, the downstream stator blades 16 of the annular row of downstream stator blades 16 that are located around the longitudinal axis X in a first angular sub-sector S2₁ of the second angular sector S2 around the longitudinal axis X are each rotated around the respective AC pitch axis so as to be in the closed-pitch configuration relative to the downstream stator blades 16 located around the longitudinal axis X in a second angular sub-sector S2₂ of the second angular sector S2 around the longitudinal axis X.

The downstream stator blades 16 of the annular row of downstream stator blades 16 that are located about the longitudinal axis X in the first angular sub-sector S2₁ are also each rotated about the respective pitch axis AC so as to be in the open-pitch configuration relative to the downstream stator blades 16 located about the longitudinal axis X in a third angular sub-sector S2₃ of the second angular sector S2 about the longitudinal axis X. The third angular sub-sector S2₃ is distinct from the first angular sub-sector S2₁ and the second angular sub-sector S2.

The first angular sub-sector S2₁ extends over an angular range of less than 90°. The second angular sub-sector S2₂ and the third angular sub-sector S2₃ each extend over an angular range greater than 90°.

The first angular sub-sector S2₁ is advantageously centred on the angular position at 3H. Such a configuration also allows for a further reduction in the noise level emitted by the turbomachine 10 in the direction of an angular position at 6H (i.e. towards the ground), in particular compared to the second configuration.

The second angular sub-sector S2₂ and the third angular sub-sector S2₃ are centred on the angular positions at 6H and 12H respectively.

FIG. 9b shows a second variant of the sixth configuration of the annual row of the downstream stator blades 16. According to the second embodiment of the sixth configuration, this differs from the first embodiment in that the first angular sector S1 and the first angular sub-sector S2₁ each extend over an angular range greater than 90° and the second angular sub-sector S2₂ and the third angular sub-sector S2₃ each extend over an angular range less than 90°.

FIG. 10 shows a seventh configuration of the annual row of downstream stator blades 16. The seventh configuration differs from the fourth configuration in that the first angular sector S1 is advantageously centred on an angular position at 12H and the first angular sub-sector S2₁ is advantageously centred on an angular position at 6H. Such a configuration reduces the level of noise emitted by the turbomachine 10 towards an angular position at 3H and an angular position at 9H (i.e. towards the cabin of an aircraft on which the turbomachine 10 is mounted, irrespective of the side of the aircraft fuselage relative to which the turbomachine 10 is mounted).

The second angular sub-sector S2₂ and the third angular sub-sector S2₃ are centred on the angular positions at 3H and 9H respectively.

According to a first variant of the seventh configuration shown in FIG. 10a, the first angular sector S1 and the first angular sub-sector S2₁each extend over an angular range of less than 90° and the second angular sub-sector S2₂ and the third angular sub-sector S2₃ each extend over an angular range of more than 90°. According to a second variant of the seventh configuration represented in FIG. 10b, the first angular sector S1 and the first angular sub-sector S2₁ each extend over an angular range greater than 90° and the second angular sub-sector S2₂ and the third angular sub-sectors S2₃ each extend over an angular range less than 90°.

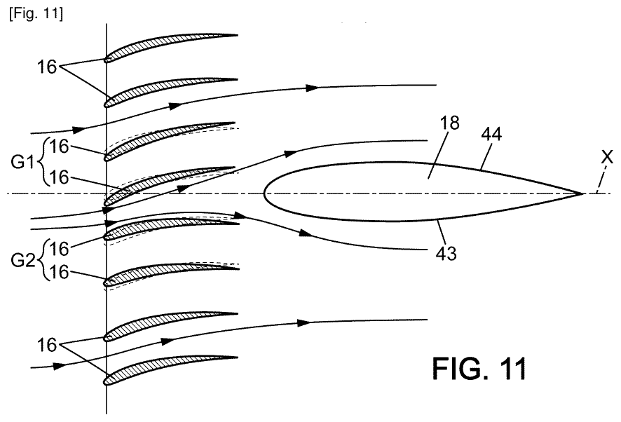

FIG. 11 shows an eighth configuration of the annular row of downstream stator blades 16. In the eighth configuration, the downstream annular stator blade array 16 of the turbomachine 10 comprises:
a first group G1 comprising two circumferentially adjacent downstream blades which each have a downstream end located circumferentially on the same side as the upper surface face 44 of the pylon 18 with respect to the radial plane, the first group G1 comprising at least the downstream stator blade 16 which is circumferentially closest to the radial plane and whose downstream end is located circumferentially on the same side as the upper surface face 44 of the pylon 18 with respect to the radial plane,
a second group G2 comprising two circumferentially adjacent downstream blades which each have a downstream end located circumferentially on the same side as the lower surface face 43 of the pylon 18 with respect to the radial plane, the second group G2 comprising at least the downstream stator blade 16 which is circumferentially closest to the radial plane and whose downstream end is located circumferentially on the same side as the lower face surface 43 of the pylon 18 with respect to the radial plane.

Each downstream stator blade 16 of the first group G1 is in a closed pitch configuration relative to each downstream stator blade 16 of the second group G2. In other words, each downstream stator blade 16 of the second group G2 is in an open-pitch configuration relative to each downstream stator blade 16 of the first group G1.

Such a configuration of the downstream annular row ensures that the downstream stator blades 16 of the first group G1 and the downstream stator blades 16 of the second group G2 are subjected to a relatively similar aerodynamic load despite air flow conditions at the level of the annular row of downstream stator blades 16 being different on either side of the radial plane due to the presence of the pylon 18.

Such an arrangement facilitates flow bypass around the pylon 18, thereby reducing a rise in pressure distortion between the pylon 18 and the downstream stator blades 16 of the first type, and avoiding boundary layer separation and the formation of recirculation zones on the downstream stator blades 16 of the first type which would increase aerodynamic losses and noise levels.

1. An aeronautical thruster (10) of longitudinal axis (X) comprising:
a hub (12),
an annular row of unducted upstream rotor blades (14) and an annular row of unducted downstream stator blades (16), each downstream stator blade (16) being of variable pitch, and
wherein at least one of the downstream stator blades (16) is in a closed-pitch configuration relative to another of the downstream stator blades (16) in that it has a pitch angle (γ) smaller than the pitch angle (γ) of the other downstream stator blade (16).

2. An aeronautical thruster (10) according to claim 1, wherein the difference between the pitch angle of two downstream stator blades (16) is less than 120°, preferably less than 60°.

3. An aeronautical thruster (10) according to claim 1, wherein the difference between the pitch angle of two circumferentially consecutive downstream stator blades (16) is less than 45°, preferably less than 20°.

4. An aeronautical thruster (10) according to claim 1, wherein the downstream stator blades (16) out of the annular row of downstream stator blades (16) that are located around the longitudinal axis (X) in a first angular sector (S1) around the longitudinal axis (X) are each in the closed-pitch configuration relative to at least one downstream stator blade (16) out of the annular row of downstream stator blades (16) that is located around the longitudinal axis (X) in a second angular sector (S2) around the longitudinal axis (X), the second angular sector (S2) being distinct from the first angular sector (S1).

5. An aeronautical thruster (10) according to claim 4, wherein the annular row of downstream stator blades (16) comprises at least two circumferentially consecutive downstream stator blades (16) in each of the first angular sector (S1) and the second angular sector (S2).

6. An aeronautical thruster (10) according to claim 4, wherein the first angular sector (S1) extends over an angular range of less than or equal to 180°, preferably less than or equal to 120°, or more preferably less than or equal to 90°.

7. An aeronautical thruster (10) according to claim 4, wherein the first angular sector (S1) is centred on an angular position selected from an angular position at 12H, an angular position at 3H, an angular position at 6H and an angular position at 9H.

8. An aeronautical thruster (10) according to claim 4, wherein the downstream stator blades (16) of the annular row of downstream stator blades (16) that are located around the longitudinal axis in a first angular sub-sector (S21) of the second angular sector (S2) around the longitudinal axis are each in the open-pitch configuration relative to the downstream stator blades (16) located around the longitudinal axis (X) in a second angular sub-sector (S22) of the second angular sector (S2) around the longitudinal axis (X), the second angular sub-sector (S22) being distinct from the first angular sub-sector (S21).

9. An aeronautical thruster (10) according to claim 8, in which the first angular sector (S1) is centred on one of angular positions at 3H and at 9H and the first angular sub-sector (S21) is centred on the other among the angular positions at 3H and at 9H, and in which the upstream rotor blades (14) are driven in a direction of rotation (R1) around the longitudinal axis (X) so that the upstream rotor blades (14) which are located in the first angular sector (S1) are rotated around the longitudinal axis (X) in a direction ranging from an angular position at 6H to an angular position at 12H and the upstream rotor blades (14) which are located in the first angular sub-sector (S21) are driven in rotation around the longitudinal axis (X) in a direction going from the angular position at 12H to the angular position at 6H.

10. An aeronautical thruster (10) according to claim 8, wherein the first angular sector (S1) is centred on an angular position at 12H and the first angular sub-sector (S21) is centred on an angular position at 6H.

11. An aeronautical thruster (10) according to claim 4, wherein the downstream stator blades (16) of the annular row of downstream stator blades (16) that are located around the longitudinal axis (X) in a first angular sub-sector (S21) of the second angular sector (S2) around the longitudinal axis (X) are each in the open-pitch configuration relative to the downstream stator blades (16) located around the longitudinal axis (X) in a second angular sub-sector (S22) of the second angular sector (S2) around the longitudinal axis (X), the second angular sub-sector (S22) being distinct from the first angular sub-sector (S21).

12. An aeronautical thruster (10) according to claim 11, wherein the first angular sector (S1) is centred on an angular position at 9H and the first angular sub-sector (S21) is centred on an angular position at 3H.

13. An aeronautical thruster (10) according to claim 11, wherein the first angular sector (S1) is centred on an angular position at 12H and the first angular sub-sector (S21) is centred on an angular position at 6H.

14. An aeronautical thruster (10) according to claim 8, wherein the first angular sub-sector (S21) extends over an angular range less than or equal to 180°, preferably less than or equal to 120°, more preferably less than or equal to 90°.

15. An aeronautical thruster (10) according to claim 4, in which each of the downstream stator blades (16) located around the longitudinal axis (X) in the first angular sector (S1) or in the second angular sector (S2), or if necessary in the first angular sub-sector (S21) of the second angular sector (S2) or in the second angular sub-sector (S22) of the second angular sector (S2), has a pitch angle(γ) which is identical to within about 1°.

16. An aeronautical thruster (10) according to claim 4, in which at least two downstream stator blades (16) located around the longitudinal axis (X) in the first angular sector (S1) or in the second angular sector (S2), or if applicable in the first angular subsector (S21) of the second angular sector (S2) or in the second angular subsector (S22) of the second angular sector (S2), have identical dimensional characteristics.

17. An aeronautical thruster (10) according to claim 4, in which at least two downstream stator blades (16) located around the longitudinal axis (X) in the first angular sector (S1) or in the second angular sector (S2), or if applicable in the first angular subsector (S21) of the second angular sector (S2) or in the second angular subsector (S22) of the second angular sector (S2), have different dimensional characteristics.

18. A propulsion system for an aircraft, the propulsion system comprising an aeronautical thruster (10) according to claim 1 and a pylon (18) adapted to attach the aeronautical thruster to a fuselage or wing of the aircraft, the pylon extending in a direction including at least a radial direction from a radially inner end by which it is connected to the hub (12) of the aeronautical thruster (10), the pylon (18) comprising a leading edge (41) and a trailing edge (42) between which extend on each side in the circumferential direction an upper surface face (44) and a lower surface face (43), the upper surface face (44) and the lower surface face (43) of the pylon (18) being, at least on an upstream part of the pylon (18) arranged circumferentially on either side of a radial plane defined by the longitudinal axis (X) and a radial axis passing, at least in part, through the leading edge (41) of the pylon (18), and wherein the annular row of downstream stator blades (16) of the aeronautical thruster (10) comprises:
a first group (G1) comprising one or more downstream blade(s) (16) which each have a downstream end located circumferentially on the same side as the upper surface face (44) of the pylon (18) with respect to the radial plane the first group (G1) comprising at least the downstream stator blade (16) which is circumferentially closest to the radial plane and whose downstream end is located circumferentially on the same side as the upper surface face (44) of the pylon (18) with respect to the radial plane,
a second group (G2) comprising one or more downstream blade(s) (16) which each have a downstream end located circumferentially on the same side as the lower surface face (43) of the pylon (18) with respect to the radial plane, the second group (G2) comprising at least the downstream stator blade (16) which is circumferentially closest to the radial plane and whose downstream end is located circumferentially on the same side as the pressure face (43) of the pylon (18) with respect to the radial plane, and
wherein each downstream stator blade (16) of the first group (G1) is in a closed-pitch configuration relative to each downstream stator blade (16) of the second group (G2).

19. A propulsion system according to claim 18, wherein the downstream stator blades (16) of the first group (G1) are circumferentially consecutive two by two and/or the downstream stator blades (16) of the second group (G2) are circumferentially consecutive two by two.

20. A method of operating the aeronautical thruster according to claim 1, the method comprising adjusting the pitch angle (γ) of each downstream stator blade (16) in dependence on an incidence phase of operation of the aeronautical thruster (10).

21. A method of operating the propulsion system according to claim 18, the method comprising adjusting the pitch angle (γ) of each downstream stator blade (16) in dependence on an incidence phase of operation of the aeronautical thruster (10).
